(19) United States
(12) Patent Application Publication
(10) Pub. No.: US 2026/0322423 A1
(43) Pub. Date: Oct. 15, 2026

(54) SIGNAL ACQUISITION IN A COMMUNICATION SYSTEM

(71) Applicants: Infineon Technologies AG, Neubiberg (DE); Infineon Technologies Switzerland AG, Zurich (CH)

(72) Inventors: Martin Krüger, Oberschleissheim (DE); Raghavasimhan Thirunarayanan, Oetwil Am See (CH)

(21) Appl. No.: 19/629,526

(22) Filed: Mar. 26, 2026

(30) Foreign Application Priority Data
Apr. 11, 2025 (DE) 102025114339.0

(51) Int. Cl. H04B 1/7163

(52) U.S. Cl. CPC H04B 1/71637; H04B 2201/71634

(57) ABSTRACT

A method for signal acquisition in a communication system, including correlating a received signal with a set of predefined templates to generate a plurality of correlation vectors. The received signal includes a pilot sequence transmitted over a communication channel. Each predefined template corresponds to the pilot sequence modified by a candidate carrier frequency offset. The method further includes calculating, for each correlation vector, a metric representing a quality parameter of the correlation. The method further includes deriving, based on the calculated metrics, an estimate of an impulse response of the communication channel.

### TECHNICAL FIELD

The present disclosure relates to methods and systems for signal acquisition and frequency estimation in mobile communication receivers, for example in the field of ultra-wideband (UWB) communication.

### BACKGROUND

UWB technology, characterized by its high bandwidth and low transmission power, may be used in applications such as keyless entry, touchless payment, and secure ranging systems. A key aspect of UWB communication is an accurate detection and processing of transmitted signals in receivers that comply with standards like IEEE 802.15.4 HRP (High Rate PHY).

Prior art methods rely on coherent channel impulse response (CIR) estimation using known data or pilot sequences, such as Ipatov sequences, to enable precise synchronization and demodulation of received signals. However, these methods may face challenges when there is a carrier frequency offset between the transmitter and receiver, which may be caused by clock mismatches, for example. Such offsets may introduce phase rotation in the received signal, leading to degraded signal-to-noise ratios (SNRs), reduced CIR estimation accuracy, and the appearance of false signal components, or “ghost taps.” Moreover, existing solutions, including incoherent signal acquisition and frequency estimation techniques, may either be computationally intensive or may suffer from noise-related inaccuracies, making them impractical for low-power, high-efficiency UWB devices.

Thus, there may be a demand to provide a method and system for signal acquisition and optionally frequency estimation that may mitigate the effects of carrier frequency offsets while maintaining efficiency and accuracy, particularly in environments with stringent power and computational constraints.

### SUMMARY

This demand is addressed by methods and apparatuses in accordance with the independent claims. Further possibly advantageous embodiments are addressed by the dependent claims.

According to a first aspect of the present disclosure, it is proposed a method for signal acquisition in a communication system, comprising correlating a received signal with a set of predefined templates to generate multiple correlation vectors. The received signal includes a pilot sequence transmitted over a communication channel. Each template corresponds to the pilot sequence modified by a candidate carrier frequency offset. For each correlation vector, a metric representing a quality parameter of the correlation is calculated, and based on these metrics, an estimate of the impulse response of the communication channel is derived.

The proposed method involves analyzing a signal received by a receiver of a communication system to extract useful information about the channel it traveled through. The received signal contains a known sequence of data, called pilot sequence, which is transmitted over the communication channel. To process this signal, the method compares it against a set of predefined reference patterns, or templates. These templates represent how the pilot sequence would look if it were altered by different potential frequency mismatches, known as carrier frequency offsets, between the transmitter and receiver.

By comparing the received signal to each template, the method generates a set of correlation vectors, which quantify how closely the signal matches each template. For each vector, the method calculates a metric that measures the quality of the match. These metrics are then analyzed to determine how the signal has been affected by the communication channel, allowing the system to estimate the channel's characteristics, such as how the signal has been delayed, distorted, or weakened. This may enable accurate signal processing by addressing signal distortions caused by channel conditions.

According to some embodiments, the communication system is a UWB communication system. UWB systems are known for transmitting data over a very wide frequency spectrum while using extremely low transmission power. This approach is particularly useful for applications like secure ranging and precise location detection, where high accuracy and low power consumption are needed. By specifying UWB as the communication system, the method may be tailored to address the unique challenges and requirements of UWB technology, such as managing high bandwidth and ensuring robustness against interference and signal degradation.

According to some embodiments, the pilot sequence includes an Ipatov sequence, and the predefined templates are based on the Ipatov sequence or a spread version thereof. Ipatov sequences are mathematical sequences with unique properties, such as ideal autocorrelation, which make them particularly well-suited for accurately identifying and synchronizing signals in communication systems. The predefined templates used in the method may either directly be derived from the Ipatov sequence or from a modified version of it, where additional zeros may be inserted to increase its length. This modification, known as spreading, may enhance compatibility with digital processing systems and may ensure the sequence can be efficiently used in correlation calculations. These choices may improve the method's ability to detect and process the received signal accurately, even in challenging environments with noise and interference.

According to some embodiments, the elements of the pilot sequence are restricted to values selected from {−1, 0, +1}. Correlating may be performed using a conditional adder-subtractor, which adds, subtracts, or ignores received samples based on the corresponding template values. In other words, the pilot sequence may be designed so that its individual elements are limited to simple values: −1, 0, or +1. This restriction may simplify the processing during correlation. When comparing the received signal to the predefined templates, a specialized component called a conditional adder-subtractor may be used. This component may perform operations based on the value of the corresponding template element. If the template element is +1, the received signal value is added to the correlation sum. If the template element is −1, the received signal value is subtracted from the correlation sum. If the template element is 0, the correlation sum remains unchanged. This approach may eliminate the need for more complex multiplications and may significantly reduce the computational load, making the method more efficient and well-suited for implementation in hardware.

According to some embodiments, correlating is performed using hierarchical summation. This involves computing initial correlation sums for subsets of received samples weighted by corresponding template values and subsequently combining intermediate sums in successive stages to obtain a final correlation output. In other words, the correlation process may be performed using a hierarchical approach to improve computational efficiency. The hierarchical summation may be organized in multiple steps. Instead of calculating the correlation in a single step, the received signal may be divided into smaller subsets, and each subset may be processed independently to compute intermediate correlation sums. These sums may be calculated by weighting the selected received signal samples with their corresponding values in the predefined templates. The intermediate results may then be combined step-by-step in successive stages, with each stage reducing the number of computations required. Steps could correspond to time steps, e.g. clock cycles, scheduler cycles, code pieces. Stages could correspond to layers of logic (digital hardware). This stepwise approach may simplify the overall process, reduce computational complexity, and allow for faster and more efficient correlation, particularly when implemented in hardware or in systems with limited processing power.

According to some embodiments, correlating involves iterative calculation of correlation sums across multiple stages. In the first stage, partial sums are calculated by combining pairs of received samples with corresponding template values. In subsequent stages, sums from the previous stage are combined in pairs until a final output is derived. In other words, the correlation process may be carried out in multiple iterative stages to streamline computation. Initially, in the first stage, pairs of received signal samples may be matched with their corresponding values from the predefined templates, and partial correlation sums may be calculated for each pair. These partial sums represent intermediate results. In the following stages, the results from the previous stage may be grouped into pairs and combined further to create new sums. This iterative process may continue, with each stage reducing the number of correlation sums, until a single final correlation output is produced. This staged approach may reduce the computational effort required for correlation and makes the process more efficient, especially in systems with high data rates or resource constraints.

According to some embodiments, the pilot sequence and the received samples are extended to a length equal to a power of two, and hierarchical summation stages halve the number of operations at each step. Extending to a length equal to a power of two may imply that the pilot sequence and the received samples may be extended by adding zeros to their ends. Extending to a length equal to a power of two may imply that the pilot sequence and the received samples may be extended by adding zeros to its beginning. Extending to a length equal to a power of two may imply that the pilot sequence and the received samples may be extended by adding zeros somewhere between the end and the middle. As a result their length becomes a power of two, such as 128 or 256. This adjustment may ensure compatibility with a convenient binary-based nomenclature. The correlation process may then be carried out in a hierarchical manner, where each stage of the summation reduces the number of operations by half. By progressively combining the intermediate results at each stage, the computational workload may be reduced, allowing for faster and more resource-efficient signal processing, particularly in hardware implementations.

According to some embodiments, the method further includes deriving an estimate of the carrier frequency offset based on the calculated metrics. In other words, the method may include an additional step where the calculated metrics, which measure the quality of the correlation for different predefined templates, are used to estimate the carrier frequency offset in the communication channel. The carrier frequency offset may occur due to slight differences between the transmitter and receiver frequencies, which can distort the received signal. By analyzing the metrics associated with the correlation process, the method may identify the frequency offset, allowing to compensate for it. This step may ensure more accurate signal processing and may improve the reliability of communication.

According to some embodiments, the set of predefined templates comprises a plurality of templates, each template corresponding to the pilot sequence modified by a different candidate carrier frequency offset. Correlating the received signal with each of the plurality of templates results in a plurality of frequency-dependent correlation vectors, each correlation vector being associated with a distinct candidate carrier frequency offset. In other words, the method may involve using a collection of predefined templates, where each template represents the pilot sequence as if it were affected by a specific potential carrier frequency offset. During the correlation process, the received signal is compared against each of these templates individually. This comparison generates a set of correlation vectors, with each vector corresponding to a specific candidate carrier frequency offset. These correlation vectors reflect how well the received signal matches the templates for different frequency offsets. By analyzing these vectors, the most likely frequency offset can be identified, enabling the system to adjust for it and ensure accurate signal processing.

According to some embodiments, each template is generated by applying one or more complex weighting factors to the pilot sequence to represent the respective candidate carrier frequency offset. Each complex weighting factor is selected from a predetermined set of discrete complex values including at least one of 0, ±1, ±j, and ±(1±j). In other words, each predefined template may be created by modifying the pilot sequence with specific complex weighting factors that represent different potential carrier frequency offsets. These weighting factors may be chosen from a predetermined set of simple complex values, such as 0, ±1, ±j (the imaginary unit), and ±(1±j). By using this set of discrete values, the method may simplify the mathematical operations needed to generate the templates, making the process more efficient and easier to implement in hardware. These templates may allow the system to account for and analyze various candidate frequency offsets in the received signal.

According to some embodiments, the complex weighting factors are determined by quantizing real and imaginary components of a sinusoidal function representative of the candidate carrier frequency offset, the quantization being performed with respect to one or more thresholds that map the real and imaginary components to the discrete complex values. In other words, the complex weighting factors used to generate the templates may be derived by taking the real and imaginary components of a sinusoidal function that represents a candidate carrier frequency offset. These components may then be quantized, meaning they are adjusted to fit within specific ranges or thresholds. This quantization process maps the components to discrete complex values, such as 0, ±1, ±j, and ±(1±j). By simplifying the weighting factors in this way, the method may reduce the computational complexity of generating the templates, making the process faster and more efficient while maintaining sufficient accuracy for analyzing the frequency offset.

According to some embodiments, correlating comprises generating, for each candidate carrier frequency offset, a corresponding correlation output, and processing each correlation output by at least one of accumulation, moving summation, or averaging filters. In other words, during the correlation process, the method may produce a correlation output for each possible carrier frequency offset by comparing the received signal to the corresponding template. These correlation outputs, which indicate how well the received signal matches each template, may then be processed further to improve their reliability and clarity. This processing may involve techniques such as accumulation, where multiple correlation results are combined over time; moving summation, where results are summed within a sliding window; or averaging filters, which may smooth out noise and variations. These techniques may help refine the correlation outputs, making it easier to identify the correct carrier frequency offset and improve overall signal accuracy.

According to some embodiments, calculating the metric for each candidate carrier frequency offset is based on the processed correlation output, and deriving the frequency offset estimate corresponds to identifying the candidate carrier frequency offset that yields the maximum metric. In other words, the method may calculate a quality metric for each candidate carrier frequency offset based on the refined correlation outputs obtained from processing steps like accumulation or filtering. This metric may serve as a measure of how well the received signal matches each predefined template. To determine the actual carrier frequency offset, the method may identify the candidate offset that corresponds to the highest metric value. This may ensure that the frequency offset estimate is derived from the best-matching template, enabling accurate compensation for the offset and improving the precision of subsequent signal processing steps.

According to some embodiments, deriving the frequency offset estimate further comprises examining metric values in a region around the most likely frequency offset and performing an interpolation operation to refine the frequency offset estimate. In other words, after identifying the candidate carrier frequency offset with the highest metric value, the method may further refine this estimate by examining metric values in a region around the most likely carrier frequency offset. By analyzing these nearby values, the method may perform an interpolation, a mathematical process that uses these surrounding data points to calculate a more precise estimate of the frequency offset. This refinement may improve the accuracy of the frequency offset determination, ensuring better compensation and enhancing the performance of the overall communication system. The metric used for interpolation may be the same metric used for selecting the most suitable candidate frequency or a different metric.

According to some embodiments, the correlation vector associated with the best metric is used to derive a channel impulse response estimate. Said channel impulse response estimate is used in subsequent processing steps such as channel equalization, demodulation, or synchronization. In other words, the correlation vector that corresponds to the highest metric value, indicating the best match between the received signal and a predefined template, may be used to estimate the channel impulse response. This estimate captures the characteristics of the communication channel, such as how it alters or delays the transmitted signal. The channel impulse response may then be utilized in subsequent processing steps, including channel equalization, which may compensate for distortions introduced by the channel; demodulation, which extracts the transmitted data from the received signal; and synchronization, which ensures accurate timing alignment between the transmitter and receiver. These steps may be needed for maintaining reliable and accurate communication.

According to some embodiments, correlating comprises simultaneously correlating the received signal with multiple predefined templates, each predefined template associated with a distinct candidate carrier frequency offset, thereby obtaining correlation results for multiple candidate carrier frequencies in parallel. In other words, the method may perform the correlation process by comparing the received signal to multiple predefined templates at the same time. Each template corresponds to a different candidate carrier frequency offset. By processing these comparisons simultaneously, the system may generate correlation results for all the candidate frequency offsets in parallel. This parallel approach may reduce the time required to analyze the signal for frequency offsets, enabling faster and more efficient signal processing while maintaining accuracy.

According to some embodiments, the correlation and metric computation are implemented in hardware using an integrated circuit configured to perform conditional addition and subtraction without multipliers. In other words, the process of correlation and metric computation may be carried out directly in hardware using a specialized integrated circuit. This circuit may be designed to handle the necessary operations, such as adding or subtracting values conditionally based on the template, without relying on multipliers. By avoiding multipliers, the hardware implementation may become simpler, faster, and more energy-efficient, making it particularly suitable for systems that require high-speed processing and low power consumption, such as UWB communication devices.

The present disclosure also proposes a computer program that, when executed on a computing device or processing system, performs the method for signal acquisition in a communication system as described. The computer program includes instructions that enable the device to correlate a received signal with a set of predefined templates, where each template represents the pilot sequence modified by a candidate carrier frequency offset, to generate multiple correlation vectors. The program further includes instructions for calculating a metric for each correlation vector, representing a quality parameter of the correlation, and for deriving an estimate of the impulse response of the communication channel based on the calculated metrics. This computer program may allow for the implementation of the disclosed method in software, making it adaptable for deployment in a wide range of communication devices and systems.

According to another aspect of the present disclosure, an apparatus for signal acquisition in a communication system is proposed. The apparatus (e.g., a receiver) comprises a processing circuit configured to correlate a received signal with a set of predefined templates to generate a plurality of correlation vectors. The received signal comprises a pilot sequence transmitted over a communication channel. Each of the predefined templates corresponds to the pilot sequence as modified by a candidate carrier frequency offset. The processing circuit configured to calculate, for each correlation vector, a metric representing a quality parameter of the correlation, and to derive, based on the calculated metrics, an estimate of an impulse response of the communication channel.

In other words, the present disclosure also proposes a device designed to perform the signal acquisition process in a communication system. This device includes a processing circuit that compares the received signal, which contains a known pilot sequence, to a set of predefined templates. Each template represents the pilot sequence as it would appear if affected by a specific candidate carrier frequency offset. The processing circuit generates multiple correlation vectors by comparing the signal to the templates. It then calculates a metric for each vector to measure the quality of the match. Based on these metrics, the processing circuit determines an estimate of the channel's impulse response, which characterizes how the communication channel has affected the transmitted signal. This apparatus enables precise signal processing, facilitating reliable communication by compensating for channel distortions and frequency offsets.

Embodiments of the present disclosure introduce a (joint) signal acquisition and frequency estimation concept for mobile communications in general and UWB impulse radio in particular. It employs a correlator to process received complex digital baseband samples using a set of templates. Each correlation vector is evaluated using one or more metrics that quantify its quality. The metric with the highest value may be used to select the optimal correlation vector for channel estimation. This approach may not only facilitate accurate CIR estimation but may also allow robust carrier frequency offset estimation, ensuring efficient signal processing even in the presence of frequency mismatches.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 illustrates a mobile communication system;

FIGS. 2A and 2B illustrate a template before and after spreading;

FIGS. 2C and 2D illustrate the template repeated 8 times;

FIGS. 2E and 2F illustrate correlation results;

FIG. 2G illustrates correlation results in case of carrier frequency offset;

FIG. 3A illustrates incoherent signal acquisition;

FIG. 3B illustrates all tap frequency estimation;

FIG. 3C illustrates frequency-compensated coherent present detection;

FIG. 4 shows a flowchart of a method for signal acquisition in a communication system according to an embodiment;

FIG. 5 shows a signal processing chain according to an embodiment;

FIG. 6 illustrates a spread pilot sequence in a matrix arrangement;

FIG. 7 illustrates a staged summation process;

FIG. 8 illustrates a modified staged summation process; and

FIG. 9 shows a signal processing chain according to another embodiment.

### DETAILED DESCRIPTION

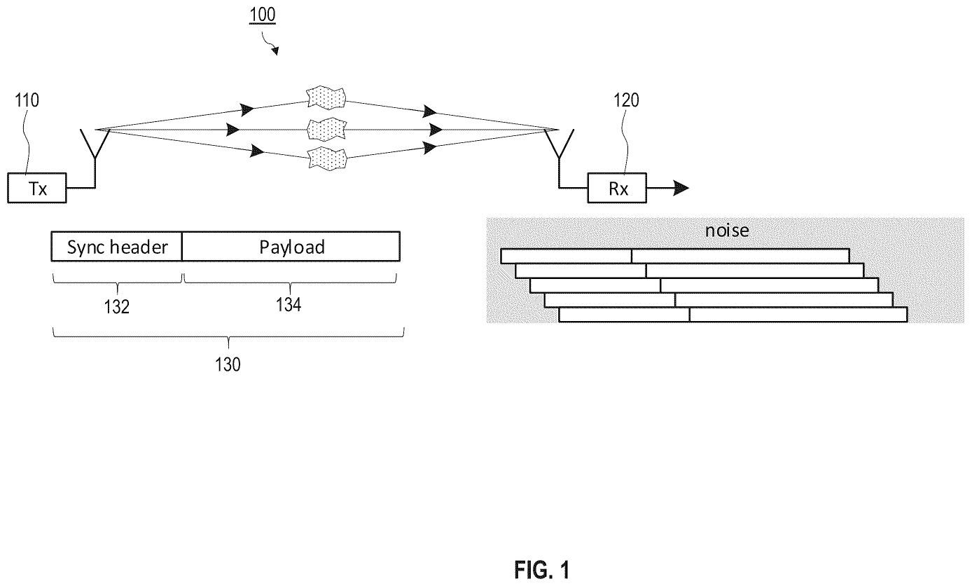

FIG. 1 illustrates a mobile communication system labeled as 100. In this system 100, a transmitter (Tx), designated as 110, is configured to send signals towards a receiver (Rx), designated as 120. The transmitter 110 and receiver 120 are connected to antennas for wireless communication. The signal transmitted by the transmitter 110 does not necessarily travel directly to the receiver 120 along a single path. Instead, it may undergo multipath propagation. Multipath propagation may occur when transmitted signals reach a receiver through multiple paths, resulting from reflections, diffractions, or scatterings caused by obstacles like buildings, mountains, or atmospheric layers. These varied paths may cause the signal components to arrive at different times and phases, leading to constructive or destructive interference. This interference can manifest as fading, where the signal strength fluctuates, potentially degrading communication quality. In digital communications, multipath propagation can introduce intersymbol interference (ISI), causing errors in data interpretation.

Embodiments of the present disclosure relate to mobile communication receivers in general, and more specifically to receivers compliant with the IEEE standard 802.15.4, HRP (High Rate PHY). The IEEE 802.15.4 standard defines the physical (PHY) and medium access control (MAC) layers for low-rate wireless personal area networks (LR-WPANs). Within this standard, the High Rate Pulse (HRP) ultra-wideband (UWB) PHY operates over carrier frequencies ranging from 3 to 10 GHZ, utilizing channel bandwidths of approximately 500 MHz. This configuration may enable high-precision ranging and localization, with accuracy often within one meter or less, making it suitable for applications requiring precise distance measurements.

HRP UWB employs pulse-based signaling, which may enhance resistance to multipath interference and allow for robust communication in challenging environments. The standard supports various data rates, accommodating diverse application requirements. Additionally, HRP UWB includes mechanisms for secure communication, incorporating features that protect data integrity and confidentiality during transmission.

As shown in FIG. 1, in IEEE 802.15.4, data may be transmitted using frames 130, which are structured sequences of bits that facilitate communication between devices in a wireless personal area network (WPAN). Each frame 130 begins with a synchronization header (SHR) 132, composed of a preamble sequence and a start-of-frame delimiter (SFD). The SHR 132 may carry pilot data known to the receiver may enable the receiver 120 to detect the presence of a frame and synchronize its timing to accurately interpret subsequent data. Following the SHR 132 is a physical layer header (PHR), which contains information about the frame length and other control data necessary for proper frame interpretation. The PHR informs the receiver about the size of forthcoming payload 134, ensuring correct data extraction.

The payload 134, also known as a MAC protocol data unit (MPDU), comprises the MAC header, the frame payload, and the frame check sequence (FCS). The MAC header includes addressing information, such as source and destination addresses, facilitating proper routing of the frame within the network. The frame payload 134 carries the actual data intended for the recipient, which can vary depending on the frame type-data, acknowledgment, beacon, or MAC command. The FCS is a cyclic redundancy check (CRC) value that allows the receiver 120 to detect errors that may have occurred during transmission, ensuring data integrity.

The receiver 120 may use the SHR 132 to detect that a packet has been transmitted and at which exact time the next fields after the SHR 132 begins so that it can successfully demodulate data of these fields. The receiver 120 may comprise a digital receiver and the processing steps described herein may refer to a discrete receive signal.

The multipath propagation can be modeled by a convolution of the transmitted signal with an complex channel impulse response (CIR) not known to the receiver. The SHR 132 allows the estimation of the CIR for proper demodulation. It allows to detect the most useful samples and to measure location parameters like the distance between transmitter 110 and receiver 120 or angle-of-arrival. Due to the complex CIR the receiver 120 needs to process complex samples.

As long as the carrier frequency of the transmitter 110 and the receiver 120 are exactly the same this task is straightforward. The pilot data known to the receiver may be derived from a sequence with ideal correlated autocorrelation properties, meaning their autocorrelation function equals zero for all non-zero lags and a constant value for a zero lag. This property makes them particularly useful in communication systems, such as the IEEE 802.15.4 standard, where they may be employed in preamble codes to facilitate synchronization and reduce interference. One example for such ideal sequences are Ipatov sequences. An Ipatov sequence is a type of ternary perfect sequence characterized by elements from the set {−1, 0, 1}. These sequences exhibit ideal periodic autocorrelation properties In the SHR 132, a spread Ipatov sequence may be repeated very often. Hence, the CIR can be determined by simply correlating the received samples with the known Ipatov sequence. In this context, the Ipatov sequence may be regarded as a predefined template or pilot sequence.

A maximum order of the CIR may be determined by the length of a spread Ipatov sequence. Assume an original Ipatov sequence has a length N, which refers to the number of elements in the sequence. To spread this sequence, a specific number of zeros may be added between each element. For example, L−1=7 zeros may be inserted between each element of the sequence. This spreading process increases the total length of the sequence to LN, where L is the number of slots occupied by each element, including the original element itself and the inserted zeros. For a sequence of original length N=127 and L=8 (since L−1=7), the new length of the spread sequence becomes LN=8×127. This spreading technique is used in communication systems to create a sequence with a larger duration, which can improve resistance to noise and interference while enabling better synchronization. The term “maximum order of the CIR” refers to the maximum number of resolvable multipath components, which is influenced by the length of the spread sequence. If the sampling rate of the receive signal is 1 GHz this means that a CIR with a delay spread of up to 1 μs can be estimated. This straightforward procedure can be denoted as coherent CIR estimation.

UWB packets may be transmitted with very low power even down to −100 dBm or less. On the other hand, the bandwidth is high so that the thermal noise is already −87 dBm increased by the inevitable noise figure of the receiver circuitry. However, the correlator output refers to the same CIR tap after LN samples. By accumulating the correlator output samples accordingly the signal-to-noise ratio of the CIR becomes reliable enough for the purposes that have been described before.

An offset between the transmitter and the receiver carrier frequency may typically be the result of a clock offset breaks the coherent CIR estimation. Since the phase is rotating over time, the accumulation will sometimes even decrease the signal-to-noise ratio.

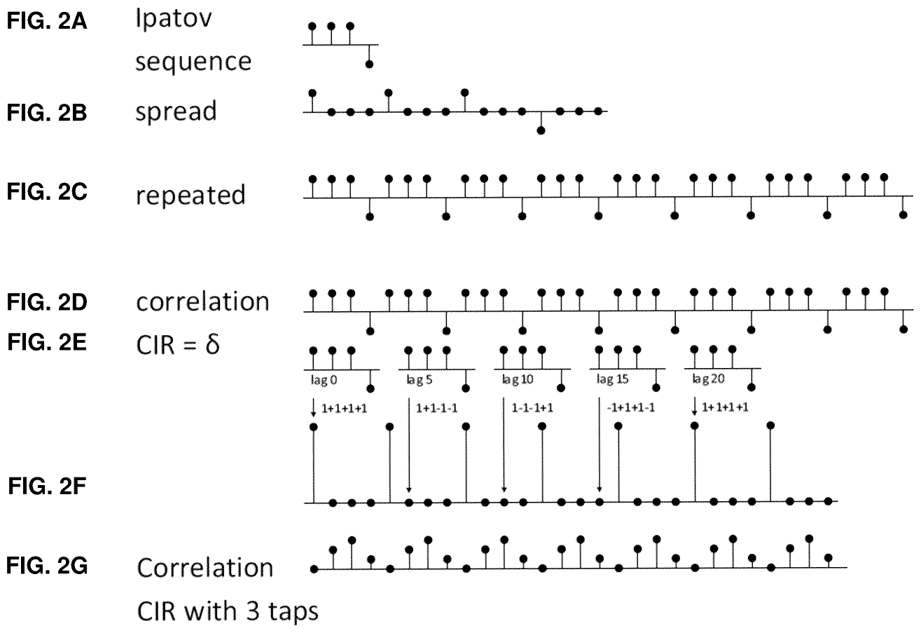

For easier understanding, consider a simple example N=4, L=1, template t₁=t₂=t₃=−t₄=1. The template before and after spreading looks like in FIG. 2A and FIG. 2B. In the illustrated example, the template is repeated 8 times (FIG. 2C). If it is transmitted over an ideal channel without noise and only one tap with value 1, the receiver 120 sees just the same signal. Now this signal is correlated with the template as shown in FIG. 2D with lags from 0 to 28.

The results for the lags 0, 5, 10, 15, 20, and 28 are explained in FIG. 2E. Note that due to the sequence length of 4, the results are the same for the lags with the same modulo 4 value:
Lag bin 1: lags 0, 4, 8, 12, 16, 20, 24, correlation sum is 1+1+1+1=4, bin sum=
Lag bin 2: lags 1, 5, 9, 13, 17, 21, 25, correlation sum is 1+1−1−1=0, bin sum=0
Lag bin 3: lags 2, 6, 10, 14, 18, 22, 26, correlation sum is 1−1−1+1=0, bin sum=0
Lag bin 4: lags 3, 7, 11, 15, 19, 23, 27, correlation sum is-1+1+1−1=0, bin sum=0

The accumulated sum per lab bin is 28 times of the tap value 1 which should lead to a high signal to noise ratio for the CIR estimation (FIG. 2F).

This changes fundamentally if the receive signal sₙ is rotated by a frequency error sₙ=tₙωⁿ. For example, if ω=j (j imaginary unit), the cyclic auto correlation changes from [4, 0, 0, 0] to [0, 2+2j, 0, 2j−2]. The true tap 1 is seen as zero and two ghost taps appear from the correlation (FIG. 2G).

In typical UWB systems, the phase rotation may not be that fast but longer templates (N=127), higher spreading factor (L=8) and accumulation over more symbol repetitions (20 or more) reduce the estimated power of the true taps and give rise to ghost taps. Hence, a channel estimation that can cope with a clock or frequency offset is desired.

Some state-of-the art solutions to this problem exist and are presented in the following: Incoherent signal acquisition, all tap frequency estimation, and multiple frequency coherent signal acquisition.

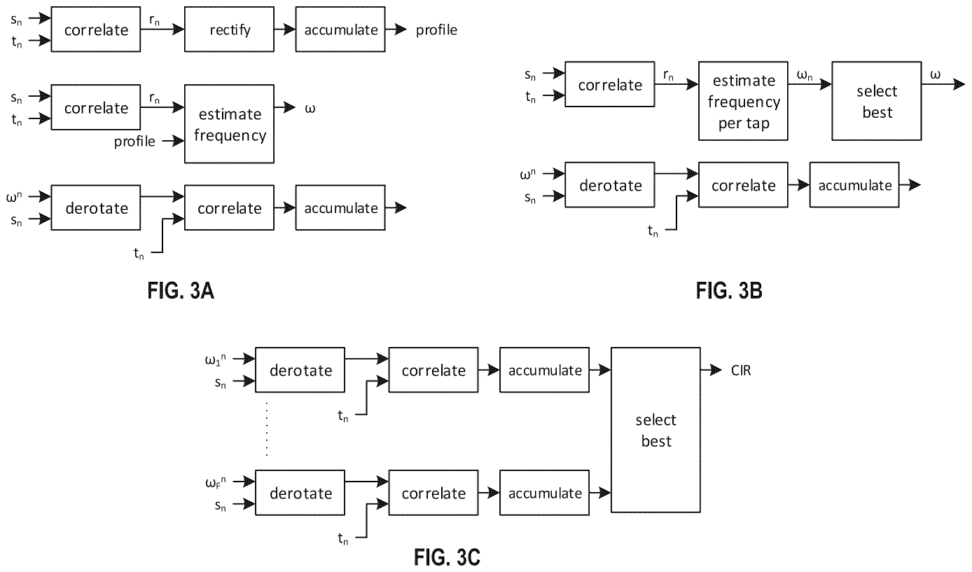

Incoherent signal acquisition (FIG. 3A): To detect that a packet is present, it is sufficient to estimate the absolute value of the CIR also denoted as CIR profile. Hence, the absolute values of the complex correlator samples (also denoted as rectified samples) are accumulated instead of the complex values. This incoherent accumulation is robust against clock offset. Once the presence of the packet has been detected, the phase of the correlator samples can be used to estimate the frequency. The CIR profile information may be used to restrict this frequency estimation to samples with sufficient signal energy. Then, the correlator samples can be accumulated with corrected phase. One disadvantage of this method is the reduced signal-to-noise ratio from the incoherent accumulation. The noise of the rectified samples may have a bias which makes the CIR profile estimation less accurate. Moreover, the sequential processing requires either a very long SHR or the buffering of a huge number of samples. While the length of the SHR is not in the hand of the receiver, the large buffer may be expensive in the implementation.

All tap frequency estimation (FIG. 3B): Another approach is the estimation of the phase already before having detected the presence of the packet. Since the CIR profile is not known yet, all candidate taps of the CIR need to be considered. Once a reliable frequency estimate has been found, the clock offset can be compensated and the coherent CIR estimation can be done. Determining the phase for all samples with a typically 1 GHz sampling rate requires a lot of divisions in short time which may be expensive in the implementation.

Frequency-compensated coherent signal acquisition (FIG. 3C): This is the complementary approach to all tap frequency estimation. The samples are compensated assuming one certain clock offset. Then the coherent signal acquisition determines a possible CIR. This is repeated with other assumed clock offset values and the best fit is picked for the final CIR estimate. Like in the previous approach this may be computationally demanding. A fast divider is not required, but a lot of complex multiplications for the frequency compensation.

Thus, existing methods, such as incoherent signal acquisition, all-tap frequency estimation, and frequency-compensated coherent signal acquisition, each have limitations that affect their efficiency and practicality. These include reduced signal-to-noise ratio, inaccuracies in channel impulse response (CIR) estimation, high computational complexity, and costly hardware requirements, such as extensive buffering or high-speed dividers. A novel approach is desired to ensure robust and accurate channel estimation while minimizing computational demands and hardware costs, ultimately enabling more reliable and efficient communication in systems subject to clock offset and other imperfections.

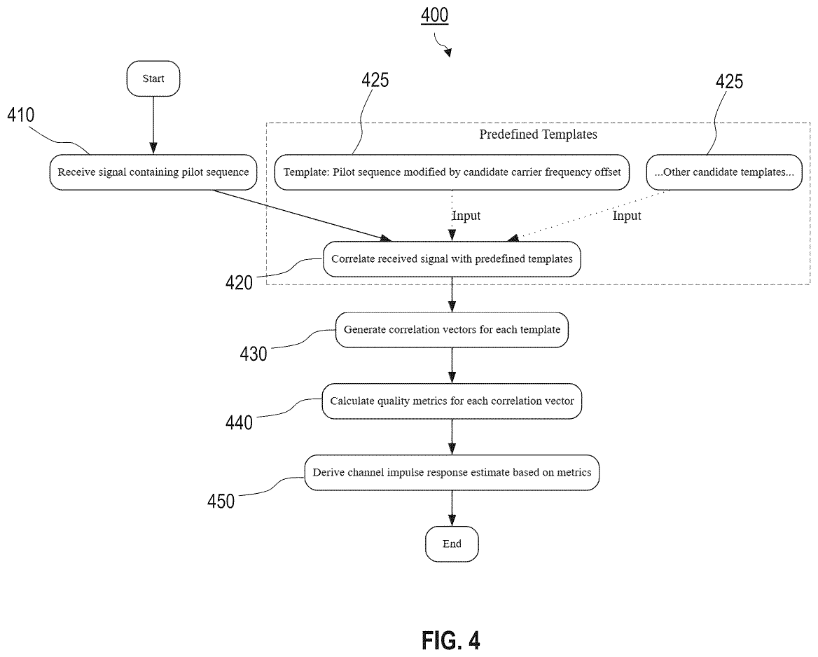

The present disclosure proposes a method 400 for signal acquisition in a communication system. A schematic flowchart of method 400 is illustrated in FIG. 4.

Method 400 includes receiving 410 a signal comprising a pilot sequence transmitted over a communication channel. Embodiments of the receiving process 410 may involve capturing a signal transmitted over a communication channel using a receiver 120 equipped with an antenna. In some embodiments, the receiver 120 may include front-end components such as filters and amplifiers to remove noise and boost signal strength, ensuring better detection of the pilot sequence. The signal may then undergo analog-to-digital conversion, where a continuous waveform is sampled and digitized for further processing. Embodiments may include multiple antennas for diversity or beamforming, improving signal reception under challenging conditions such as interference or multipath propagation. Additionally, the receiver 120 may incorporate software-defined radio (SDR) capabilities, enabling flexible adaptation to different communication protocols and frequency bands.

Method 400 includes correlating 420 the received signal with a set of predefined templates to generate 430 a plurality of correlation vectors. Each of the predefined templates 425 corresponds to the pilot sequence as modified by a candidate carrier frequency offset. Embodiments of the correlating process 420 may involve comparing the received signal with a set of predefined templates to identify patterns that match the received pilot sequence. Each template represents the pilot sequence as it would appear if modified by a specific candidate carrier frequency offset. In some embodiments, this correlation process may be performed in the time domain, where the received signal is directly matched against the templates by calculating their dot products or cross-correlations. In other embodiments, the correlation may be performed in the frequency domain by first applying a Fourier transform to the received signal and the templates. The correlating process 420 may be implemented using hardware such as digital signal processors (DSPs) or field-programmable gate arrays (FPGAs) or application-specific integrated circuits (ASICs), which are capable of performing these operations in real time. Alternatively, the process may be carried out in software, using algorithms that compute correlation metrics for each template. Advanced embodiments may include parallel processing techniques, where multiple templates are simultaneously correlated with the received signal to speed up computation. This step may produce a plurality of correlation vectors, with each vector representing the degree of similarity between the received signal and a specific template, thereby enabling further analysis and estimation in subsequent steps of the method 400.

Method 400 further includes calculating 440, for each correlation vector, a metric representing a quality parameter of the correlation. Embodiments of the calculating process 440 involve determining a metric for each correlation vector that quantifies the quality of the correlation between the received signal and the predefined templates. This metric may represent parameters such as the signal-to-noise ratio (SNR), peak correlation value, or energy associated with the correlation vector. In some embodiments, the metric may be calculated by identifying the maximum amplitude of the correlation vector, which indicates the strongest match between the received signal and a specific template. Other embodiments may use statistical measures, such as averaging or integrating the values of the correlation vector, to assess its overall quality. The calculation process may be performed using hardware components like digital signal processors (DSPs) or application-specific integrated circuits (ASICs) for real-time operation. Alternatively, software implementations may rely on optimized algorithms to compute the metric for each correlation vector efficiently. In advanced embodiments, the calculation may involve adaptive techniques that account for varying noise levels or channel conditions, ensuring that the quality metric accurately reflects the reliability of the correlation. This step may provide information for subsequent decision-making, enabling the derivation of the CIR or other parameters essential for the communication system's performance.

Method 400 further includes deriving 450, based on the calculated metrics, an estimate of an impulse response of the communication channel. Embodiments of the deriving process 450 may involve using the calculated metrics from the correlation vectors to estimate the CIR of the communication channel. This process interprets the metrics to identify the temporal and amplitude characteristics of the channel, which represent how the transmitted signal propagates through it. In some embodiments, the process may involve selecting the correlation vector with the highest metric as the primary contributor to the impulse response. This approach assumes that the template with the strongest match corresponds to the actual conditions of the channel. Advanced embodiments may combine information from multiple correlation vectors to construct a more comprehensive and accurate estimate of the CIR. Techniques such as weighted averaging or least-squares optimization can be used to integrate the contributions of various metrics, accounting for noise and multipath effects. The deriving process 450 may also include filtering or smoothing to refine the impulse response estimate and eliminate artifacts introduced by noise or interference. This step can be implemented in hardware using field-programmable gate arrays (FPGAs) or application-specific integrated circuits (ASICs) for real-time processing, or in software using algorithms designed to handle complex mathematical operations. The resulting CIR estimate may provide information about the channel, enabling the communication system to perform tasks such as equalization, synchronization, and data recovery more effectively.

An advantage of using different templates representing the pilot sequence as modified by various candidate carrier frequency offsets, compared to using only the pilot sequence itself, is the ability to account for and mitigate the effects of frequency mismatches between the transmitter and receiver. In practical communication systems, factors such as oscillator inaccuracies, Doppler shifts, or relative motion can introduce carrier frequency offsets. By correlating the received signal with a range of templates, each reflecting a potential frequency offset, the system can detect and adapt to these frequency shifts more effectively. This approach may increase the robustness of signal acquisition, enhance synchronization accuracy, and improve the overall reliability of the communication link, especially in dynamic or noisy environments.

The proposed method 400 may be implemented using hardware, software, or a combination of both, depending on the system requirements and constraints. In a hardware implementation, the method may be executed using a digital signal processor (DSP), application-specific integrated circuits (ASICs), or field-programmable gate arrays (FPGAs), which may be well-suited for high-speed signal processing tasks. These hardware components can efficiently handle the complex operations involved in correlating signals, calculating metrics, and deriving the channel impulse response in real-time. Alternatively, the method may be implemented in software running on a general-purpose processor or a system-on-chip (SoC), enabling flexibility and ease of updates for different communication scenarios. Example software may include signal processing algorithms written in programming languages such as C or Python, or frameworks like MATLAB, designed to perform correlation, metric calculations, and optimization. Additionally, hybrid implementations leveraging both hardware and software may be employed to balance computational efficiency with adaptability, ensuring optimal performance in diverse communication environments.

Method 400 can be implemented in receiver 120 to enable efficient and robust signal acquisition in communication system 100. The receiver 120 may be equipped with the necessary hardware and software capabilities to execute the steps of the method, including receiving a transmitted signal, correlating it with predefined templates, calculating quality metrics for the correlation vectors, and deriving an estimate of the channel impulse response. The hardware components of the receiver 120, such as digital signal processors (DSPs), field-programmable gate arrays (FPGAs), and analog-to-digital converters (ADCs), can handle high-speed signal processing tasks required by method 400. Additionally, the software running on receiver 120 can implement advanced algorithms for correlation, metric calculation, and channel estimation, ensuring flexibility and adaptability to different communication scenarios. By integrating the method into the receiver 120, the system can achieve precise synchronization, reliable channel estimation, and effective mitigation of challenges such as frequency offsets and multipath propagation. This integration ensures that the receiver 120 can fully support the functionality required for modern communication systems.

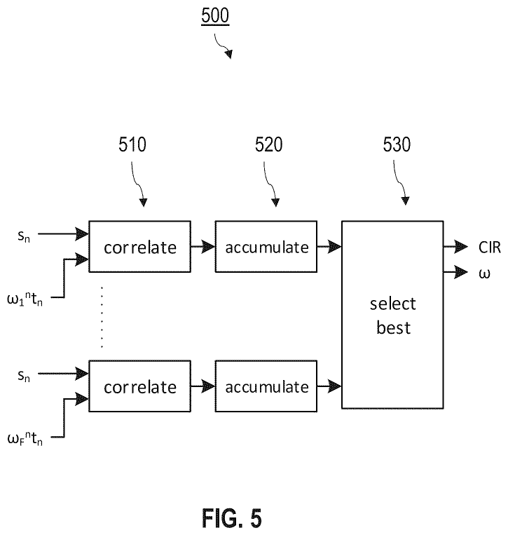

The basic principle of the proposed concept is illustrated in FIG. 5. A signal processing chain 500 may comprise three primary stages arranged sequentially: a correlation stage 510, an accumulation stage 520, and a selection stage 530. An input to the processing chain 500 is represented as a received signal sₙ, which is provided to multiple correlation blocks in parallel. Each correlation block also receives a pilot sequence as modified by a respective candidate carrier frequency offset, denoted as w_{f}ⁿtₙ. The output of each correlation block is connected to the respective accumulation block. The accumulated results from all paths are then fed into the selection stage 530, which may output an estimated channel impulse response (CIR) and an estimated carrier frequency offset ω.

The correlation stage 510 receives the input signal sₙ and compares it with a series of predefined templates modified by candidate carrier frequency offsets. Each correlation block computes the similarity between the received signal and its respective template, producing correlation vectors. These vectors are then passed to the accumulation stage 520, where the correlator outputs may be summed over time to enhance the signal-to-noise ratio (SNR). This accumulation step may ensure that even weak signals can be reliably identified and analyzed.

Outputs from the accumulation blocks, which may represent metrics of correlation quality for each candidate carrier frequency offset, are provided to the selection stage 530. The selection stage 530 may evaluate the accumulated results to identify the best candidate frequency offset and its associated CIR, which may be output for further use.

Method 400 can be used for joint signal acquisition and frequency estimation for UWB impulse radio, where the correlation stage 510 correlates the received complex digital baseband samples sₙ with a set of templates ω_{f}tₙ thus providing a set of correlation vectors. From each correlation vector a metric quantifying the quality of the correlation vector may be calculated. The best metric selects the best correlation vector as CIR estimate. Optionally, one or more metrics may be used to estimate the carrier frequency offset w.

In some embodiments, the pilot sequence comprises an Ipatov sequence. An Ipatov sequence is a type of ternary perfect sequence comprising elements from the set {−1, 0, 1}, known for its ideal periodic autocorrelation properties, where out-of-phase autocorrelation coefficients are zero. This characteristic makes Ipatov sequences particularly useful in communication systems for tasks such as synchronization and channel estimation. Alternatives to Ipatov sequences may include m-sequences (maximum length sequences) and Legendre sequences, both of which exhibit favorable autocorrelation properties. M-sequences are binary sequences generated using linear feedback shift registers and are valued for their long periods and uniform spectral characteristics. Legendre sequences, derived from quadratic residues, also possess good autocorrelation features, making them suitable for various applications in communications and radar systems.

For example, a spread Ipatov sequence may be transmitted over a multipath propagation channel. A spread Ipatov sequence refers to an Ipatov sequence that has been modified by inserting additional zeros between its elements. By spreading the sequence, the spacing between consecutive elements is extended, typically by adding a fixed number of zeros. This process increases the total length of the sequence while preserving its autocorrelation properties. Moreover, noise is added. This can be expressed in a channel model

$${s}_{n} = {\sum }_{v = 1}^{N} {h}_{v} {t}_{[ n - 1 + 1 ]} + {z}_{n}$$

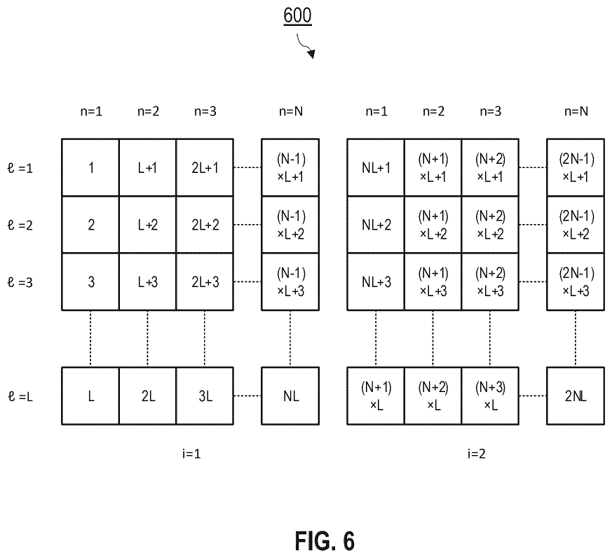

Here tᵥ denotes the Ipatov sequence elements and the [ . . . ] operator wraps the numbers into the range 1, . . . , N. The receiver samples may be grouped into (L, 1) vectors sₙ and the same may be done with the noise zₙ and the CIR hᵥ. See also FIG. 6 for a sample arrangement.

The first column (n=1) in FIG. 6 corresponds to the first spread sample of the pilot sequence (Ipatov sequence) spread by spreading factor L, which creates a first set of L samples. The second column (n=2) then represents the second spread sample of the pilot sequence, producing a subsequent set of L samples, and so forth. This notation illustrates how the pilot sequence is repeated or spread over multiple groups of samples, each group occupying a block of size L, until the entire sequence of length N has been fully processed. As a result, FIG. 6 reveals a systematic progression of sample blocks, each identified by a pair of indices (n and I), making it easier to see how the received signal sₙ can be segmented and processed in a multipath environment.

For the noise we may assume

$${z}_{ℓ , n} ∼ N ( 0 , {σ}_{Z}^{2} ) ,$$

i.e. white Gaussian noise. A correlator may provide a channel estimate

$${r}_{n} = {\sum }_{v = 1}^{N} {t}_{v} {s}_{v + n - 1} = {Qh}_{n} + {\overline{z}}_{n}$$

Here, Q denotes the number of non-zero template chips (here, “chip” refers to an individual element within a spread Ipatov sequence). For the averaged noise we obtain

$${\overline{z}}_{i} = {\sum }_{v = 1}^{N} {t}_{v} {z}_{v + n - 1}$$

$$and$$

$${\overline{z}}_{ℓ , n} ∼ N ( 0 , Q {σ}_{z}^{2} )$$

The correlator hardware can be implemented in a way that exploits the possible value of −1, 0, and 1 for tᵥ. I.e. r″=r′+tᵥs′ may be implemented as a conditional adder/subtractor that subtracts s′ if tᵥ=−1 does not subtract or add anything if tᵥ=0 and adds s′ if tᵥ=1.

Thus, the correlator may compute a channel estimate by summing products of the incoming samples sₙ with the known pilot or template sequence tᵥ, which itself contains elements that can be −1, 0, or 1. Because the template elements take on these simple discrete values, the correlator hardware may be realized in a particularly efficient way: it adds the sample if the template element is 1, subtracts the sample if the template element is −1, and does nothing (neither adds nor subtracts) if the template element is 0. This design may leverage the fact that the noise is white Gaussian with a known variance and that each non-zero template element contributes to the correlator output in a predictable manner, thus allowing the channel estimate to emerge as a sum of the signal components plus an averaged noise component whose variance scales with the number of non-zero template chips.

In some embodiments, correlating 420 comprises iteratively calculating correlation sums across multiple stages. In a first stage, partial correlation sums may be computed by combining pairs of received samples with corresponding template values. In each subsequent stage, the correlation sums from the previous stage may be further combined in pairs until a final correlation output is obtained. Mathematically, this can be expressed as

$$\begin{matrix}{r}_{n}^{11} = {t}_{1} {s}_{n} + {t}_{2} {s}_{n + 1} , {r}_{n}^{12} = {t}_{3} {s}_{n + 2} + {t}_{4} {s}_{n + 3} , … , {r}_{n}^{1 ( {N}^{′} / 2 )} = {t}_{{N}^{′} - 1} {s}_{n + {N}^{′} - 2} + {t}_{{N}^{′}} {s}_{n + {N}^{′} - 1} \\ {r}_{n}^{21} = {r}_{n}^{11} + {r}_{n}^{12} , {r}_{n}^{22} = {r}_{n}^{13} + {r}_{n}^{14} , … , {r}_{n}^{2 ( {N}^{′} / 4 )} = {r}_{n}^{1 ( {N}^{′} / 2 - 1 )} + {r}_{n}^{1 ( {N}^{′} / 2 )} \\ ⋮ \\ {r}_{n}^{g 1} = {r}_{n}^{( g - 1 ) 1} + {r}_{n}^{( g - 1 ) 2} , {r}_{n}^{γ 2} = {r}_{n}^{( g - 1 ) 3} + {r}_{n}^{( g - 1 ) 4} , … , {r}_{n}^{9 ( {N}^{′} / ( 2 g ) )} = {r}_{n}^{( g - 1 ) ( {N}^{′} / g - 1 )} + {r}_{n}^{( g - 1 ) ( {N}^{′} / g )} \\ ⋮ \\ {r}_{n} = {r}_{n}^{( Id {N}^{′} - 1 ) 1} + {r}_{n}^{( Id {N}^{′} - 1 ) 2}\end{matrix}$$

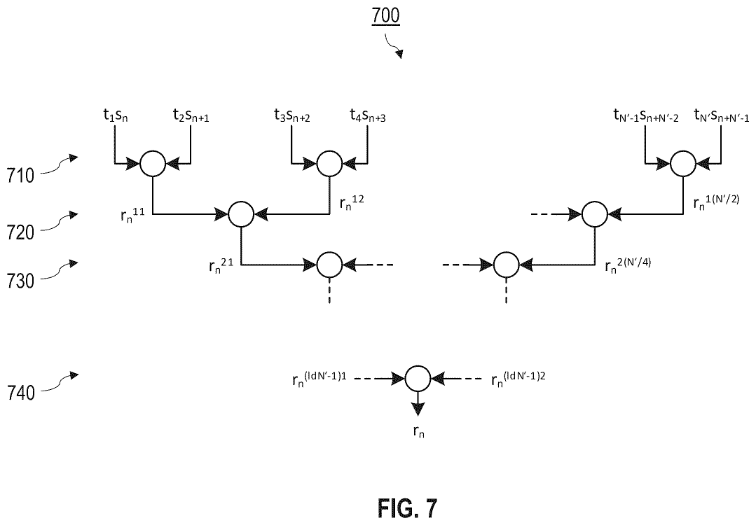

This describes a staged summation process 700 in which partial sums of the product of template elements and incoming samples are computed in successive iterations. As illustrated in FIG. 7, in a first iteration 710 of staged summation process 700, each pair of template chips and corresponding samples

$$( e . g . , {r}_{n}^{11} = {t}_{1} {s}_{n} + {t}_{2} {s}_{n + 1} )$$

may be summed to create partial correlation values

$$( e . g . , {r}_{n}^{11} ) .$$

In subsequent iterations or stages 720, 730, these partial sums may be added together in pairs

$$( e . g . , {r}_{n}^{21} = {r}_{n}^{11} + {r}_{n}^{12} ) ,$$

reducing the total number of sums at each step and gradually building up to the final correlation result 740

$$( e . g . {r}_{n} = {r}_{n}^{( Id {N}^{′} - 1 ) 1} + {r}_{n}^{( ID {N}^{′} - 1 ) 2} .$$

The notation

$${r}_{n}^{gk}$$

refers to sums computed at iteration stage g, where each sum is formed by adding the relevant partial sums from the preceding stage. The notations N′ and IdN′ are explained later. By the time the last iteration is performed, all partial sums have been combined into a single correlation value rₙ, which represents the overall result of correlating the sequence of length N′ with the received samples.

In each stage of staged summation process 700, half of the sums from the previous stage are merged to form fewer, larger sums. This process repeats until it produces a single final sum corresponding to the entire correlation. Because the length of the Ipatov sequence N may not match a power of two, a slightly longer length N′, which is a power of two (for example 128 instead of 127), may be used by padding the sequence with zeros. The base-2 logarithm of N′, denoted Id(N′), determines the number of stages required for the iterative summation. This systematic approach leverages the fact that each element in the Ipatov sequence can be −1, 0, or 1, enabling the hardware to implement additions and subtractions in a highly structured manner that reduces computational complexity.

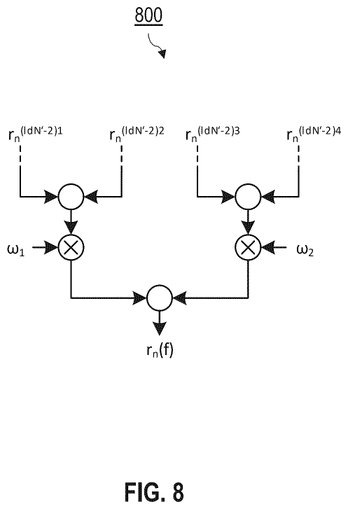

As shown in FIG. 8, the iterative summation process 700 may be modified by multiplying each partial sum from the previous stage by a complex weight ωᵣ. These weights may take on only a few discrete values, such as 0, ±1, ±j, ±1±j, where j is the imaginary unit. By introducing these factors at stage g, the template used for correlation effectively changes, which allows the correlator to adapt to, for example, carrier-frequency offsets or other phase rotations in the received signal. Limiting the weights to discrete values may simplify the hardware implementation, because multiplication by 0, ±1, ±j, ±1±j can be done through sign changes or quadrant shifts instead of general complex multiplications. This method, therefore, may provide a coherent and efficient way to modify the correlation for different frequency or phase conditions while keeping the computational complexity low.

For stage g, this can be mathematically expressed as

$$\begin{matrix}{r}_{n}^{g 1} ( f ) = {ω}_{1} ( {r}_{n}^{( g - 1 ) 1} + {r}_{n}^{( g - 1 ) 2} ) \\ {r}_{n}^{g2} ( f ) = {ω}_{2} ( {r}_{n}^{( g - 1 ) 3} + {r}_{n}^{( g - 1 ) 4} ) \\ ⋮ \\ {r}_{n}^{γ ( {N}^{′} / ( 2 g ) )} ( f ) = {ω}_{{N}^{′} / ( 2 g )} ( {r}_{n}^{( g - 1 ) ( \frac{{N}^{′}}{g} - 1 )} + {r}_{n}^{( g - 1 ) ( {N}^{′} / g )} )\end{matrix}$$

For stage g=IdN′−2, this is depicted in FIG. 8.

Thus, each template may be generated by applying one or more complex weighting factors to the pilot sequence to represent the respective candidate carrier frequency offset. This may be an efficient way to implement the correlation with a modified template. It is particularly efficient, if all of are one of 0, ±1, ±j, ±1±j, where j is the imaginary unit.

The complex weighting factors may be determined by quantizing real and imaginary components of a sinusoidal function representative of the candidate carrier frequency offset. The quantization may be performed with respect to one or more thresholds that map the real and imaginary components to the discrete complex values. One suitable rule can be

$$\begin{matrix}{ω}_{i} = ℚ ( cos ( 2 π {ft}_{i} ) ) - j ℚ ( sin ( 2 π {ft}_{i} ) ) \\ ℚ ( x ) = \{ \begin{matrix}+ 1 , & if x > θ \\ 0 , & if \vert x \vert < θ \\ - 1 , & if x < - θ\end{matrix}\end{matrix}$$

This may replace the correlator output rₙ by a set of candidate-carrier-frequency-offset-dependent correlator outputs rₙ(f) which can be further processed coherently by accumulation, moving sum, moving average, or any other filter. If we denote the filtered correlator by bₙ(f) then we can define a metric y(f) that quantifies the quality for each frequency f.

Thus, the system may use discrete complex weighting factors, derived by approximating the cosine and sine of a candidate frequency offset, to modify the correlation output (or the pilot sequence). Each real or imaginary component of the sinusoidal function representing the offset frequency may be compared against one or more thresholds, thus mapping it to a limited set of values, such as −1, 0, or +1. In practice, the real part of the cosine and the imaginary part of the sine may be quantized according to these thresholds, which yields a small set of discrete factors that can be readily implemented in hardware. When these factors replace the original correlator output, the result is a plurality of frequency-adjusted correlation outputs, each of which can then be refined through additional filtering or accumulation. A “metric” may be derived from these filtered outputs to quantify how well each candidate frequency offset aligns with the received signal.

For example if aₙ(f) is a norm of aₙ(f), e.g. aₙ(f)=|bₙ(f)| or aₙ(f)=|Rebₙ(f)|+|Imbₙ(f)| the and aₙ_{_{Max}}(f) is largest component of aₙ(f), the metric can be y(f)=aₙ_{_{Max}}(f) or

$$y ( f ) = max ( {a}_{{n}_{Max} + 1} ( f ) , {a}_{{n}_{Max} - 1} ( f ) ) + {a}_{{n}_{Max}} ( f ) .$$

This means that the system may form a metric by looking at the magnitude of the filtered correlator output bₙ(f), denoted as aₙ(f). If aₙ(f) is defined, for example, as the absolute value |bₙ(f)| or as the sum of the absolute values of the real and imaginary parts, the system may locate the maximum of these magnitudes and may label it aₙ_{_{Max}}(f). The metric y(f) may simply be this maximum or may also include the neighboring values around aₙ_{_{Max}}(f) to refine the estimate of how effectively the candidate frequency aligns with the received signal.

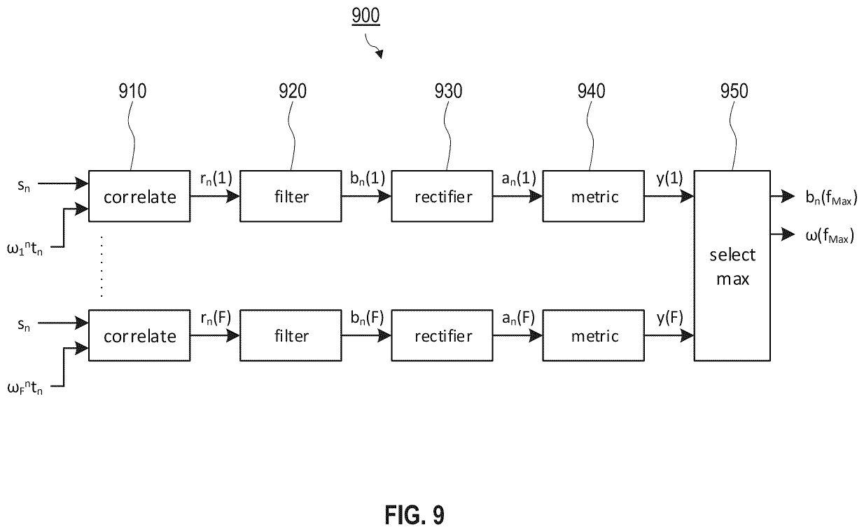

Now, f=f_{Max} with maximum metric y(f_{Max}) can be chosen as frequency estimate. The correlator output bₙ(f) can then be used for the CIR estimation and related processing. This means that the system may select the frequency value fax that maximizes the chosen metric y(f), treating f_{Max} as the estimated carrier-frequency offset. Having identified this frequency, the system may use the corresponding correlator output bₙ(f_{Max}) to estimate the channel impulse response (CIR) and perform any other signal-processing steps that rely on an accurate frequency offset estimate. This process is shown in FIG. 9.

FIG. 9 builds on FIG. 5 and shows a plurality of parallel signal paths, each path for a different candidate carrier frequency offset. In the upper path for the first candidate carrier frequency offset ω₁, boxes from left to right are labeled “correlate,” “filter,” “rectifier,” and “metric,” finally leading to a box labeled “select max.” The lower path for candidate carrier frequency offset w_{F} mirrors this sequence of boxes—“correlate,” “filter,” “rectifier,” “metric”—and likewise connects to the same final “select max” box.

In the “correlate” block 910, the incoming receive samples are correlated with the pilot sequence as modified by the respective candidate carrier frequency offset. The output of the correlator 910 is passed to a “filter” block 920, where further smoothing, averaging, or frequency-dependent processing can take place. The “rectifier” block 930 may then convert the possibly complex or signed samples into magnitude or absolute values, ensuring that any phase component is removed in the process. The “metric” block 940 may compute a numerical measure y(f) of quality or alignment that reflects how well the respective candidate frequency (or other parameter) matches the received signal. Finally, the “select max” block 950 may compare the metrics from the parallel paths and select the candidate with the highest metric value, which may then be used for subsequent operations such as carrier-frequency offset estimation or channel impulse response determination.

Moreover, several y(f) may be used to get a better estimate for frequency, e.g. quadratic interpolation using y(f_{Max}−1), y(f_{Max}), y(f_{Max}+1). Similar is possible with bₙ(f). This means that the proposed system can refine its frequency estimate by examining not just the maximum metric y(f_{Max}), but also the neighboring values y(f_{Max}−1) and y(f_{Max}+1). By fitting a quadratic function through these points, the system can interpolate to locate a more precise frequency estimate. A similar approach can be taken with alternative metrics \tilde{y}(f) of the correlator outputs bₙ(f) at 920, allowing for finer resolution in the estimation of the carrier-frequency offset.

Embodiments of the present disclosure may address limitations of prior art signal acquisition when there is a carrier frequency offset, which can occur due to mismatches between the transmitter and receiver clocks. Such offsets introduce phase rotation in the received signal, degrading the signal-to-noise ratio (SNR) and the accuracy of CIR estimation while causing “ghost taps,” or false signal components. Furthermore, existing solutions are either computationally intensive, requiring significant hardware resources, or suffer from noise-related inaccuracies, making them unsuitable for low-power, high-efficiency UWB devices.

Embodiments of the present disclosure may mitigate the effects of carrier frequency offsets while ensuring accurate and efficient signal acquisition. Embodiments of the present disclosure involve correlating the received signal with a set of predefined templates, where each template represents the pilot sequence as modified by a candidate carrier frequency offset. This process generates correlation vectors, and for each vector, a metric is calculated to quantify the quality of the correlation. Based on these metrics, the system derives an estimate of the channel impulse response (CIR) and optionally the carrier frequency offset. This approach may enable robust signal acquisition even in the presence of frequency mismatches.

The present disclosure describes various embodiments. Embodiments can be adapted for UWB systems, leveraging the unique requirements of high bandwidth and low power. In some embodiments, the pilot sequence is an Ipatov sequence or its spread or its zero-padded version, which may simplify correlation processing. Correlation can be performed using hierarchical summation, iteratively combining subsets of samples to reduce computational complexity. Additional embodiments involve simultaneously correlating the signal with multiple templates representing different frequency offsets and using metrics to select the best match. The system may refine the frequency offset estimate through interpolation and use the selected correlation vector to estimate the CIR. Hardware implementations may include integrated circuits performing conditional addition and subtraction without multipliers, enhancing efficiency. Embodiments can also include filtering and averaging to improve the reliability of correlation outputs, ensuring accurate frequency and channel estimation.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

1. A method for signal acquisition in a communication system, comprising:
correlating a received signal with a set of predefined templates to generate a plurality of correlation vectors,
wherein the received signal comprises a pilot sequence transmitted over a communication channel,
wherein each of the predefined templates corresponds to the pilot sequence as modified by a candidate carrier frequency offset;
calculating, for each correlation vector, a metric representing a quality parameter of the correlation; and
deriving, based on the calculated metrics, an estimate of an impulse response of the communication channel.

2. The method of claim 1, wherein the communication system is an ultra-wideband impulse radio system.

3. The method of claim 1, wherein the pilot sequence comprises an Ipatov sequence, and the predefined templates are based on the Ipatov sequence or a spread version thereof.

4. The method of claim 1, wherein elements of the pilot sequence are restricted to values selected from the set {−1, 0, +1}, and wherein the correlating comprises using a conditional adder-subtractor configured to:
add a received sample to a correlation sum if the corresponding template value is +1;
subtract a received sample from the correlation sum if the corresponding template value is −1; and
leave the correlation sum unchanged if the corresponding template value is 0.

5. The method of claim 1, wherein the correlating comprises:
using a hierarchical summation, wherein a correlation is initially computed in subsets to produce intermediate correlation sums of selected received samples weighted by corresponding template values, and wherein the intermediate correlation sums are subsequently combined at successive stages until a final correlation output is obtained.

6. The method of claim 1, wherein the correlating comprises iteratively calculating correlation sums across multiple stages, wherein:
in a first stage, partial correlation sums are computed by combining pairs of received samples with corresponding template values; and
in each subsequent stage, the correlation sums from the previous stage are further combined in pairs until a final correlation output is obtained.

7. The method of claim 5, wherein the hierarchical summation is performed in stages that halve the number of operations at each subsequent stage.

8. The method of claim 1, further comprising:
deriving, based on the calculated metrics, an estimate of a carrier frequency offset of the communication channel.

9. The method of claim 1, wherein the set of predefined templates comprises a plurality of templates, each template corresponding to the pilot sequence modified by a different candidate carrier frequency offset, and wherein correlating the received signal with each of the plurality of templates results in a plurality of frequency-dependent correlation vectors, each correlation vector being associated with a distinct candidate carrier frequency offset.

10. The method of claim 1, wherein each template is generated by applying one or more complex weighting factors to the pilot sequence to represent the respective candidate carrier frequency offset, and wherein each complex weighting factor is selected from a predetermined set of discrete complex values including at least one of 0, ±1, ±j, and ±(1±j).

11. The method of claim 10, wherein the complex weighting factors are determined by quantizing real and imaginary components of a sinusoidal function representative of the candidate carrier frequency offset, the quantization being performed with respect to one or more thresholds that map the real and imaginary components to the discrete complex values.

12. The method of claim 8, wherein the correlating comprises generating, for each candidate carrier frequency offset, a corresponding correlation output, and processing each correlation output by at least one of accumulation, moving summation, or averaging filters.

13. The method of claim 12, wherein the calculating the metric for each candidate carrier frequency offset is based on the processed correlation output, and deriving the frequency offset estimate corresponds to identifying the candidate carrier frequency offset that yields the maximum metric.

14. The method of claim 13, wherein the deriving the frequency offset estimate further comprises:
examining metric values in a region around the frequency offset estimate and performing an interpolation operation to refine the frequency offset estimate.

15. The method of claim 1, wherein the correlation vector associated with the best metric is used to derive a channel impulse response estimate, and wherein the channel impulse response estimate is used in subsequent processing steps such as channel equalization, demodulation, or synchronization.

16. The method of claim 1, wherein the correlating comprises:
simultaneously correlating the received signal with multiple predefined templates, each predefined template associated with a distinct candidate carrier frequency offset, thereby obtaining correlation results for multiple candidate carrier frequencies in parallel.

17. The method of claim 1, wherein the correlation and metric calculation are implemented in hardware using an integrated circuit configured to perform conditional addition and subtraction without multipliers.

18. An apparatus for signal acquisition in a communication system, the apparatus comprising a processing circuit configured to:
correlate a received signal with a set of predefined templates to generate a plurality of correlation vectors, wherein the received signal comprises a pilot sequence transmitted over a communication channel, and wherein each of the predefined templates corresponds to the pilot sequence as modified by a candidate carrier frequency offset;
calculate, for each correlation vector, a metric representing a quality parameter of the correlation; and
derive, based on the calculated metrics, an estimate of an impulse response of the communication channel.
